(19) United States
(12) Patent Application Publication
(10) Pub. No.: US 2009/0109593 A1
(43) Pub. Date: Apr. 30, 2009

(54) Hard disk drive component processing tubular wriststrap cord holder

(76) Inventors: Melvin J.A. Dela Pena, Laguna (PH); Mary Jane Frial, Binan Laguna (PH); Lorna M. Sayco, Cavite (PH); Madona B. Tolentino, Cavite (PH)

Correspondence Address: HITACHI C/O WAGNER BLECHER LLP, 123 WESTRIDGE DRIVE, WATSONVILLE, CA, 95076, US

(21) Appl. No.: 11/981,869

(22) Filed: Oct. 31, 2007

(51) Int. Cl. H05F 3/02; A45F 5/00

(52) U.S. Cl. 361/220; 24/3.1

(57) ABSTRACT

The present invention provides a tubular wrist-strap cord holder that retains a wrist-strap cord used by an operator to install components during the manufacturing of hard disk drives in order to provide grounding to the operator as the operator handles electrically sensitive components and also to provide mobility to the operator within the assembly floor. In one embodiment. The tubular wrist-strap cord holder is made of polyurethane material and comprises of a plurality of apertures for allowing for the insertion of a grounding cord, a retaining hole that allows the tubular wrist-strap cord holder to be attached to a surface work space and a slit or opening that runs the length of the tubular wrist-strap cord holder to enable the operator to insert and remove the grounding cord as needed.

### TECHNICAL FIELD

The present invention relates generally to a method and a system for manufacturing and fabricating hard drive components in a manufacturing environment, and more particularly, to limiting electromagnetic interference and electrostatic discharge in hard drive components during manufacturing using an anti-static tubular wriststrap cord holder.

### BACKGROUND ART

In many processing and computing systems, magnetic data storage devices, such as disk drives are utilized for storing data. A typical disk drive includes a spindle motor having a rotor for rotating one or more data disks having data storage surfaces, and an actuator for moving a head carrier arm that supports transducer (read/write) heads, radially across the data disks to write data to or read data from concentric data tracks on the data disk.

In the manufacturing of the disk drive, many components with high electrical sensitivities are fabricated and manufactured. Devices such as the heads, sliders, etc., have electrical sensitivities to electromagnetic interferences or electrostatic discharge that requires the manufacturing environment worker to exercise great caution in the manufacturing of these components. Components such as suspensions comprise of conductive materials which tend to have conductive traces that are typically supported by insulative materials to help reduce the potential for electrostatic discharge or electromagnetic interference. When the suspension or similar components come into contact with each other.

Several manufacturing techniques have been adopted to reduce the amount of electrostatic discharge that occurs as the hard disk drive components are manufactured and assembled in the manufacturing environment. Some of these techniques include requiring assembly workers to wear electrostatic straps when they move the hard disk drive components about the manufacturing environment. These electrostatic straps help conduct electrostatic charges away from the components to ground.

Other methods used in limiting electrostatic discharge have involved a temporary conduct that shunts the conductive traces, e.g., during the attachment of components to each other,

However, none of these techniques have been successful in substantially limiting electromagnetic interference at the material constitution level of these components. The techniques currently used are also cumbersome for the assembly floor workers as workers move about the assembly floor.

The use of electrostatic limiting accessories such as wrist-straps afford the assembly floor operator some degree of mobility in a work area. However, these conventional solutions are expensive and are typically constructed with material that are inflexible and non-durable.

Therefore, what is need is a flexible way of component fabrication and manufacturing that permits static charges to be controllably dissipated from the materials used in the construction of these components such that the potential damage from electrostatic discharge or electromagnetic interference to electric components connected to such components is reduced.

### SUMMARY

In accordance with certain aspects of the present invention, there is provided system and method for reducing electromagnetic interference or electrostatic discharge limiting features and designed for use in the fabrication and manufacture of hard disk drive components.

In one embodiment, the electromagnetic interference limiting feature of the present invention provides a tubular wrist-strap cord holder that retains a wrist-strap cord used by an operator to install components during the manufacturing of hard disk drives in order to provide grounding to the operator as the operator handles electrically sensitive components and also to provide mobility to the operator within the assembly floor. In one embodiment. The tubular wrist-strap cord holder is made of polyurethane material and comprises of a plurality of apertures for allowing for the insertion of a grounding cord, a retaining hole that allows the tubular wrist-strap cord holder to be attached to a surface work space and a slit or opening that runs the length of the tubular wrist-strap cord holder to enable the operator to insert and remove the grounding cord as needed.

### BRIEF DESCRIPTION OF THE DRAWINGS

The accompanying drawings, which are incorporated in and constitute a part of the specification, illustrate embodiments of the invention, and together with the general description given above and the detailed description given below serve to explain the teachings of the invention.

FIG. 1 is a plan view of an HDD with cover and top magnet removed with a serial identification label affixed to it in accordance with one embodiment of the present invention.

FIG. 2A is a block diagram illustration of a planar view of a tube utilized in the construction of the tubular cord holder according to one embodiment of the present invention.

FIG. 2B is a block diagram illustration of the tubular cord holder of one embodiment of the present invention with the construction of the slit opening according to one embodiment of the invention.

FIG. 3A is a block diagram illustration of the tubular wrist-strap cord holder of one embodiment of the invention.

FIG. 3B is a block diagram illustration of the tubular wrist-strap cord holder of one embodiment of the invention with a grounding cord.

### BEST MODES FOR CARRYING OUT THE INVENTION

Reference will now be made in detail to the alternative embodiment(s) of the present invention. While the invention will be described in conjunction with the alternative embodiment(s), it will be understood that they are not intended to limit the invention to these embodiments. On the contrary, the invention is intended to cover alternatives, modifications and equivalents, which may be included within the spirit and scope of the invention as defined by the appended claims.

Furthermore, in the following detailed description of the present invention, numerous specific details are set forth in order to provide a thorough understanding of the present invention. However, it will be recognized by one of ordinary skill in the art that the present invention may be practiced without these specific details. In other instances, well known methods, procedures, components, and circuits have not been described in detail as not to unnecessarily obscure aspects of the present invention.

The discussion will begin with an overview of a hard disk drive and components connected therewith. The discussion will then focus on embodiments of a method and system for limiting electrostatic discharge or electromagnetic interference during the manufacturing of the hard disk drive in a disk drive assembly environment by providing a flexible tubular wrist-strap cord holder for enabling an operator to remaining in a resonance frequency range consistent with that of components handled during the manufacturing of the hard disk drive.

### Overview

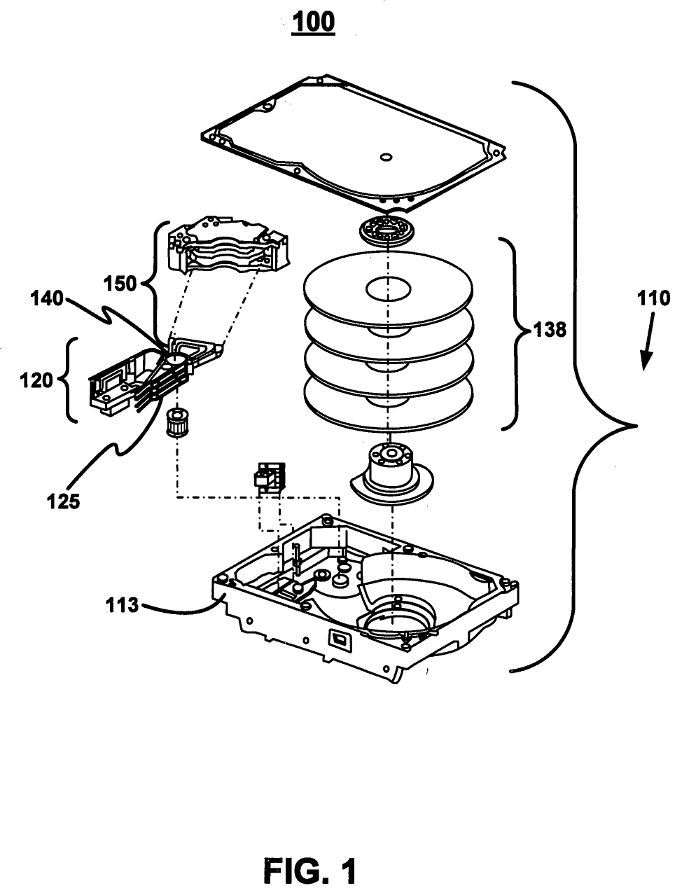

In general, the HDD comb (also referred to as an E-block) serves as a platform on which the suspensions (compliant members containing sliders with recording heads) are mounted. The recording heads fly at a constant height (on the order of nanometers) above the disk surface tracking pre-written servo information. An HDD carriage assembly (as shown in FIG. 1) forms the primary motive mechanical system that enables a disk-drive to randomly access data to be written or recorded on the disk surfaces.

With reference now to FIG. 1 a schematic drawing of one embodiment of an information storage system including a magnetic hard disk file or drive 110 for a computer system is shown. Hard disk drive 110 has an outer housing or base 113 containing a disk pack having at least one media or magnetic disk 138. The disk pack (as represented by disk 138) defines an axis of rotation and a radial direction relative to the axis in which the disk pack is rotatable.

A spindle motor assembly having a central drive hub 140 operates as this axis and rotates the disk 138 or disks of the disk pack in the radial direction relative to housing 113. An actuator 120 includes a plurality of parallel actuator arms 125 in the form of a comb that is movably or pivotally mounted to base/housing 113 about a pivot assembly 140. A controller 150 is also mounted to base 113 for selectively moving the comb of arms relative to the disk pack (as represented by disk 138).

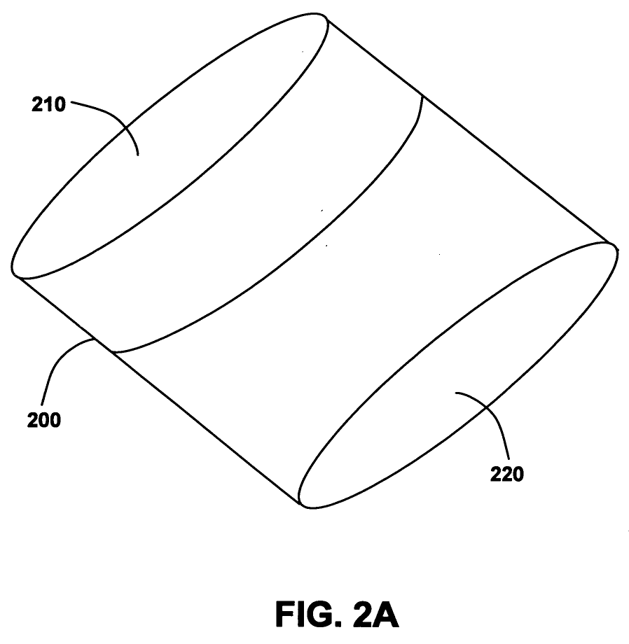

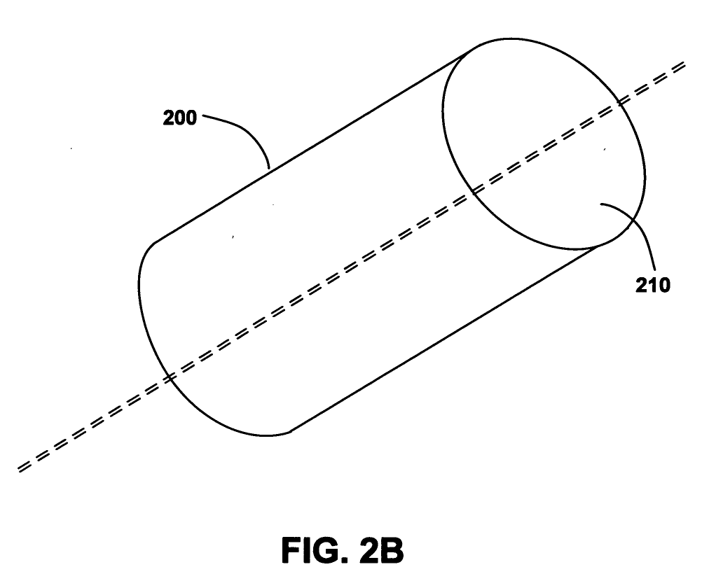

With reference now to FIGS. 2A and 2B is shown an exemplary tubular material utilized by the present invention in the construction of the tubular wrist-strap cord holder of one embodiment of the present invention. As depicted in FIG. 2A the tubular material 200 has two spherical apertures 210 and 220. The tubular material is then perforated along a vertical length as depicted in FIG. 2B to form a “C” shaped structure. In one embodiment of the present invention, the tubular material is a flexible and durable material that gives the operator the flexibility of attaching a cord to a work surface and the comfort of moving around the work station. In one embodiment, the tubular material is a polyurethane material. Alternatively, the tubular material may be a durable rubber material or a similar material of the same characteristics.

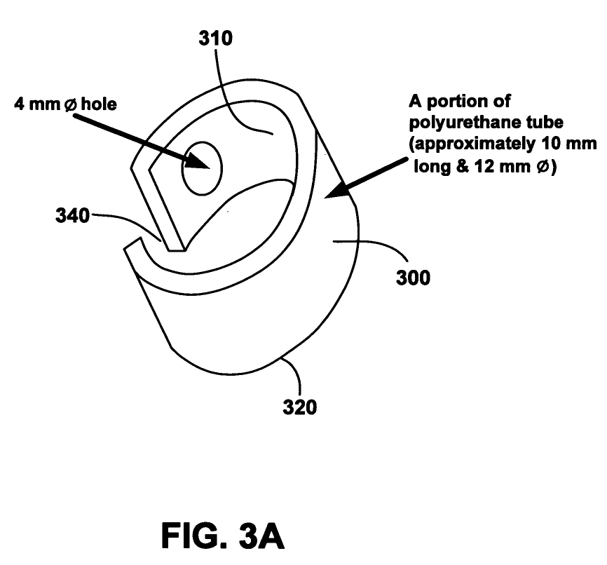

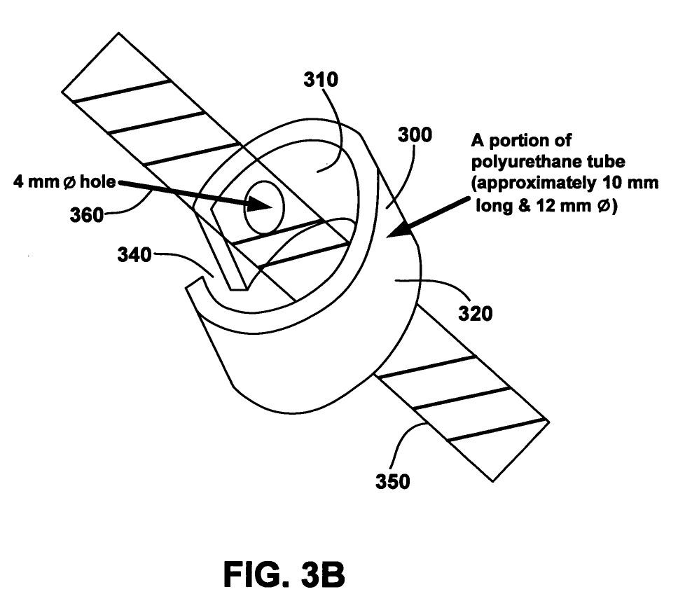

FIG. 3A depicts the cord retainer of one embodiment of the present invention with the tubular material 300 having been perforated lengthwise. In one embodiment, the vertical slit cut in the tubular material 300 is about 10 mm ling and the apertures 310 and 320 each have a diameter of about 12 mm. Of course as any one skill in the art could see, the tubular material 300 could be cut to any dimension depending on the particular application.

A retaining opening 360 is also cut in the cord retainer 300 on a surface of the retainer 300 closer to the lower aperture to provide a means for attaching the cord retainer 300 to a work surface. In one embodiment, the opening 320 is spherical with a diameter of about 4 mm.

In one embodiment of the present invention, the apertures 310 and 320 allow a cord connected to a grounding source throw one of the apertures and a work end of the cord to be attached to the operator to enable the operator to stay with the perimeter of the work station and within a frequency range consistent with the that of the grounding source. This provides an anti-electrostatic environment for the hard disk drive components being handled by the operator.

In use, a cord 340 such as a grounding strap is inserted into the tubular cord holder 300 through apertures 310 and 320. The tubular cord holder 300 is then attached to the work station by applying a screw through the opening 320 to the work station. The slit 360 allows the operator the flexibility of movement within the work area and also the ability to disengage from the retainer 300. In one embodiment, the slit 340 is tight enough in order not to allow a cord to slip out of the cord holder 300. In one embodiment, the slit 340 is centered between the apertures 310 and 320 and is narrow enough to allow the cord to be rigidly held in place by the retainer 360.

Example embodiments of the present technology are thus described. Although the subject matter has been described in a language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A tubular wrist-strap cord holder, comprising:
a flexible “C” shaped tubular retaining body;
a slit running a length of the tubular retaining body; and
an attachment gap for fixably mounting the tubular retaining body to a surface.

2. The tubular wrist-strap cord holder of claim 1, wherein the tubular retaining body comprise a first and a second aperture at a first and a second end of the tubular retaining body respectively.

3. The tubular wrist-strap cord holder of claim 2, wherein each of the first and the second apertures has a diameter of approximately 12 mm.

4. The tubular wrist-strap cord holder of claim 3, wherein the tubular retaining body is made of a polyurethane material.

5. The tubular wrist-strap cord holder of claim 3, wherein the tubular retaining body is made of a durable rubber material.

6. The tubular wrist-strap cord holder of claim 5, further comprising a third retaining aperture for receiving and retaining a grounding cord attached to an operator for limiting electrostatic discharge by hard disk drive components handled by the operator.

7. The tubular wrist-strap cord holder of claim 6, wherein the attached gap is a circular hole perforated in the side of the third aperture for retaining screws that attach the tubular wrist-strap cord holder to a work surface.

8. The tubular wrist-strap cord holder of claim 7, wherein the hole has a diameter of approximately 4 mm.

9. The tubular wrist-strap cord holder of claim 8, wherein the tubular wrist-strap cord holder is made of an anti-electrostatic discharge material.

10. The tubular wrist-strap cord holder of claim 9, wherein the tubular wrist-strap cord holder is made of a conductive material.

11. The tubular wrist-strap cord holder of claim 9, wherein the tubular wrist-strap cord holder is made of a non-conductive material.

12. A method of manufacturing a tubular wrist-strap cord holder, comprising:
providing a polyurethane tubular material;
perforating the polyurethane material horizontally into a specific length;
vertically perforating the polyurethane material to form a “C” shape tubular device; and
perforating a retaining hole on a side of the “C” shaped tubular device for attaching screws to the “C” shaped tubular device.

13. The method of claim 12, wherein the “C” shaped tubular device comprises a first cord retaining aperture for retaining a grounding cord adapted for use by an operator handling electrically sensitive hard disk drive components.

14. The method of claim 13, wherein the “C” shaped tubular device further comprises a second and a third circular apertures for receiving the grounding cord.

15. The method of claim 14, wherein the second and the third circular apertures each has a diameter of approximately 12 mm.

16. The method of claim 12, wherein the retaining hole has a diameter of approximately 4 mm.
